(19) United States
(12) Patent Application Publication
(10) Pub. No.: US 2022/0237433 A1
(43) Pub. Date: Jul. 28, 2022

(54) DATA DRIVEN RECOGNITION OF ANOMALIES AND CONTINUATION OF SENSOR DATA

(71) Applicant: Robert Bosch GmbH, Stuttgart (DE)

(72) Inventors: Tianpeng Bu, Hangzhou (CN); Chen Qiu, Sindelfingen (DE); Maja Rita Rudolph, Tuebingen (DE)

(21) Appl. No.: 17/570,542

(22) Filed: Jan. 7, 2022

(30) Foreign Application Priority Data
Jan. 15, 2021 (DE) 10 2021 200 344.3

(51) Int. Cl. G06N 3/04; G06N 3/08

(52) U.S. Cl. CPC G06N 3/0445; G06N 3/08

(57) ABSTRACT

A computer-implemented method for training a machine learning system. The method includes: providing at least one training data set that includes a number of numerical vectors; propagating numerical values of the at least one training data set by a parameterizable generic flow-based model, the parameterizable generic flow-based model including a concatenation of at least two parameterizable submodules, each submodule being one parameterizable function each; and learning the model parameter of the parameterizable generic flow-based model; parameterizations of each parameterizable submodule being learned successively in the flow direction and being fixed before parameterizations of the parameterizable submodule next in the flow direction are learned, and the learning being directed at output data of each submodule being distributed according to a predetermined probability distribution.

### FIELD

The present invention relates to methods for training and applying a computer-implemented machine learning system, in particular, for recognizing anomalies in technical systems and/or for continuing sensor data.

### BACKGROUND INFORMATION

The development and application of data-driven algorithms in technical systems are of increasing importance in digitization and, in particular, in the automation of technical systems. A technical problem may be frequently reduced to obtaining the best possible knowledge and/or information about a future development of at least one time series, which is fed, for example, from at least one sensor. On the one hand, it may be advantageous in technical systems to assess newly detected data points with respect to their compatibility with already known data points of the at least one time series and thus to recognize anomalies or outliers. On the other hand, it may be advantageous to generate new data points and, in particular, a large number of data points for the at least one time series. In this way, it is possible, for example, to simulate and statistically evaluate various future scenarios. The technical system may then be adapted or reconfigured on the basis of the estimated continuation of the at least one time series as a function of an anomaly recognition and/or of simulative results.

### SUMMARY

A first aspect of the present invention relates to a first computer-implemented method 200 for training a machine learning system 100. In accordance with an example embodiment of the present invention, the method 200 includes providing at least one training data set 210 that includes a number of numerical vectors 211 and the propagation of numerical vectors 211 of the at least one training data set 210 using a parameterizable generic flow-based model 110. The parameterizable generic flow-based model 110 includes a concatenation 121 of at least two parameterizable submodules 120, 122, each submodule 120, 122, 123 being one parameterizable function each. First computer-implemented method 200 further includes the learning of the model parameters of parameterizable generic flow-based model 110. In this case, parameterizations of each parameterizable submodule 120 are learned successively in the flow direction and fixed before parameterizations of parameterizable submodule 122 next in the flow direction are learned. The learning is directed at output data of each submodule 120, 122, 123 being distributed according to a predetermined probability distribution.

A second aspect of the present invention relates to a second computer-implemented method 300 for applying a trained machine learning system 100. In accordance with an example embodiment of the present invention, machine learning system 100 includes at least two submodules 120 and is configured and trained according to the first method and as described herein, and at least one application data set 310 that includes a number of further numerical vectors 311 being capable of being propagated in parameterizable generic flow-based model 110.

A third aspect of the present invention relates to a computer-implemented system for training or for applying a trained machine learning system 100, which is designed for at least the first method and/or for the second method and as described herein, numerical vectors 211 of the at least one training data set 210 and/or the further numerical vectors 311 of the at least one application data set 310 passing into the computer-implemented system via at least one sensor signal 410.

As described herein, the predictive power of machine learning system 100, and thus also that of provided second computer-implemented method 300 as well as that of computer-implemented system may be improved by provided first computer-implemented method 200. In addition, a complexity of the machine learning system with similar predictive power may be reduced by a gradual extension of the machine learning system by submodules, as compared to some conventional methods, in which a chain of submodules of a predetermined length is trained so that the output of the last submodule and thus of the chain exhibits a predetermined probability distribution (for example, a normal distribution).

### BRIEF DESCRIPTION OF THE DRAWINGS

FIG. 1A schematically shows a first computer-implemented method 200 for training a machine learning system 100, in which, for example, three submodules 120, 122, 123 are successively learned and frozen in the flow direction in three steps 124, 125, 126, in accordance with an example embodiment of the present invention.

FIG. 1B schematically shows a generic autoregressive flow 140 including a recurrent neural network, a so-called 1-layer RNNAF.

FIG. 1C schematically and by way of example shows a concatenation of three generic autoregressive flows 140 each including, for example, a recurrent neural network, a so-called 3-layer RNNAF.

FIG. 2 shows a flowchart for a first computer-implemented method 200 for training a machine learning system 100, in accordance with an example embodiment of the present invention.

FIG. 3A shows a flowchart for a second computer-implemented method 300 for applying a machine learning system 100, a probability distribution 213 for a time series 311 being calculated, on the basis of which a new data point 312 of time series 311 may be assessed and, if necessary, recognized as an anomaly with respect to the compatibility with time series 311, in accordance with an example embodiment of the present invention.

FIG. 3B shows a further flowchart for a second computer-implemented method 300 for applying a machine learning system 100, a time series 311 being continued starting from normally distributed random variables 314 and in the counter-flow direction, in accordance with an example embodiment of the present invention.

FIG. 4 schematically shows a vehicle 400 including at least one sensor 410 for detecting and analyzing surroundings, in accordance with an example embodiment of the present invention.

### DETAILED DESCRIPTION OF EXAMPLE EMBODIMENTS

The methods described herein may have a complexity and, in particular, a high calculation accuracy, and are therefore implemented in a computer-implemented system, the computer-implemented system including at least one processor, at least one working memory as well as at least one interface for inputs and outputs.

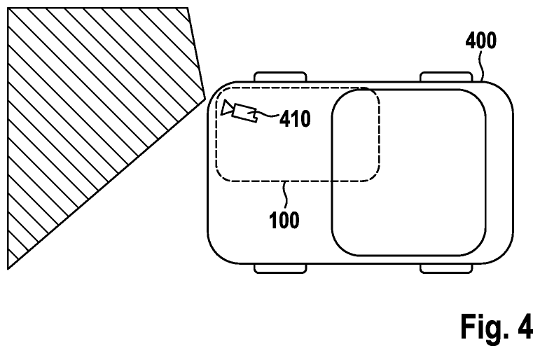

The machine learning systems described herein may be designed for various applications. In one example, a machine learning system may be designed for monitoring and/or controlling an at least semi-autonomous vehicle. In this case, the machine learning system may be coupled to at least one sensor 410 for detecting a sensor signal or sensor data, in order to receive and to process sensor data. As outlined in FIG. 4, the machine learning system may, for example, be a part of an electronic control unit of an at least semi-autonomous vehicle 400 and sensor 410 may be a part of a camera system, radar system and/or LIDAR system for detecting the surroundings and/or further road users. Further application examples are explained below.

The methods introduced herein may be adapted and designed to obtain the best possible knowledge and/or information about a future development of at least one time series 212 (which may, for example, include sensor data). In one example, the time series may include a sequence of image data. This gain in knowledge or information is achieved by a machine learning system 100, which is trained or taught on the basis of a training data set 210 that includes a number of numerical vectors 211. If numerical vectors 211 in the at least one training data set 210 represent time series 212, a probability distribution 213 for time series 212 may be learned. The method and systems presented here may then be designed for the purpose of recognizing anomalies (or also: outliers) in at least one time series 212, in particular, where the at least one time series 212 includes sensor data 410. A device or a system, in which the machine learning systems presented here is used, may be designed for the purpose of showing a corresponding reaction in response to the recognized anomaly. In the exemplary case of autonomously driving vehicle 400, an anomaly may, for example, be considered to be seen if the course of a surroundings condition and/or of a road user (for example, of a child or of an animal) suddenly changes, for example, if a child carelessly runs across the road in front of vehicle 400. Autonomous driving vehicle 400 may then react thereto and, for example, initiate an emergency brake application.

The methods and systems may further be designed for the purpose of continuing at least one time series 212 in a simulative manner. Alternatively, numerical vectors 211 of training data set 210 are not limited to time series 212, but may also contain other data such as, for example, color information for the pixels of an image.

The provided first computer-implemented method 200 is aimed at training machine learning system 100. The method includes initially providing at least one training data set 210 that includes a number of numerical vectors 211, numerical vectors 211 being capable as previously described of representing, for example, one time series or multiple time series 212, in particular, sensor data 410 in a technical system. The method further includes propagating numerical vectors 211 of the at least one training data set 210 using a parameterizable generic flow-based model 110, the parameterizable generic flow-based model 110 being a function parameterizable by model parameters, which includes a concatenation 121 of at least two parameterizable submodules 120, 122, each submodule 120, 122, 123 in turn also being one parameterizable function. The method further includes the learning of the model parameters of parameterizable generic flow-based model 110. In this case, it may prove to be advantageous if the learning takes place progressively: in this case the parameterizations (i.e., the model parameters) of each parameterizable submodule 120 are learned successively in the flow direction and fixed before parameterizations of parameterizable submodule 122 next in the flow direction are learned. The learning is directed at output data of each submodule 120, 122, 123 being distributed according to a predetermined probability distribution. The expression “the learning being directed at” indicates that the learning objective is sometimes also already achieved if a difference of the distributions of the output data and of the predetermined probability distribution is below a particular measure (for example, determined using the Kullback-Leibler divergence discussed further below). It is not necessary for the predetermined probability distribution (for example, a normal distribution) to be precisely achieved.

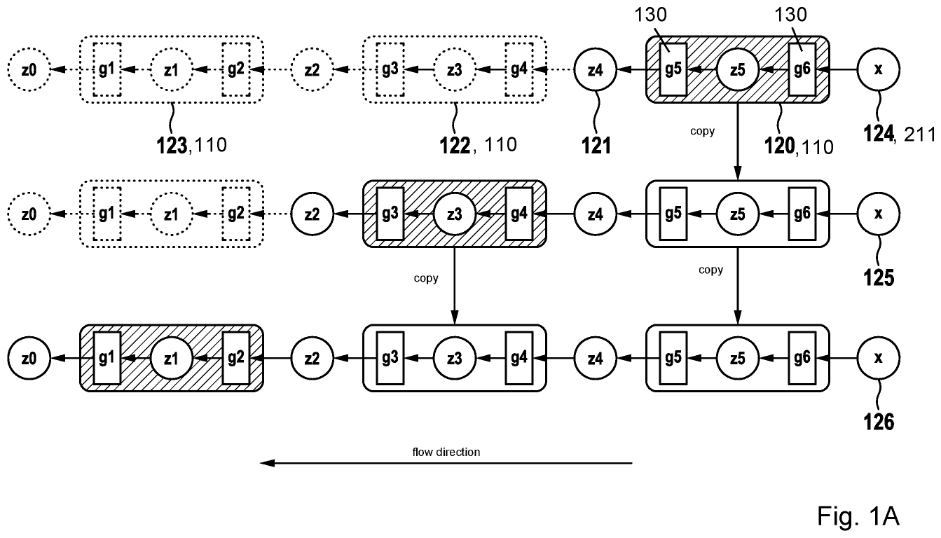

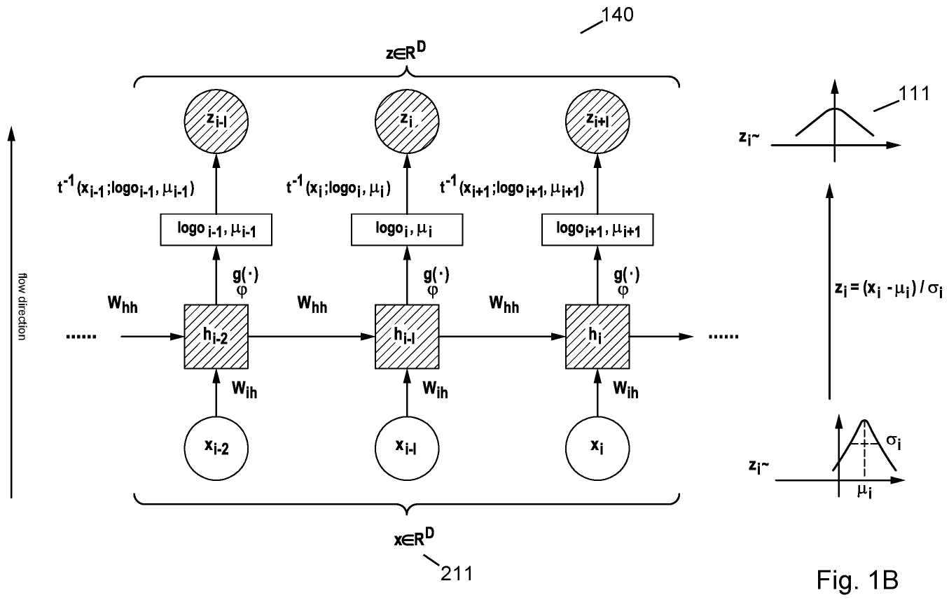

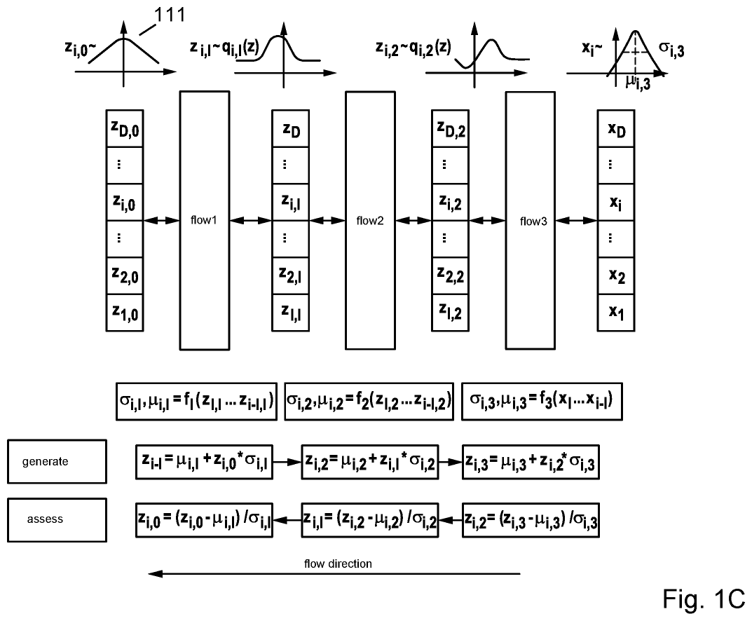

This progressive learning process is schematically shown in FIG. 1A for the exemplary case of a parameterizable generic flow-based model 110 made up of three submodules 120, 122, 123, the parameterizable generic flow-based model 110 in general being capable of including an arbitrarily large number of submodules (for example, more than three or more than six). Since submodules 120, 122, 123 may be considered to be functions, the flow direction results from the successive implementation (composition) of functions. Numerical vectors 211, [symbol] ={x⁽¹⁾, . . . , x^{(N)}|x⁽ⁱ⁾∈ [symbol] ^{D}^{ᵢ}, Dᵢ∈ [symbol] ⁺}, schematically also identified with x, may be mapped in a first training step 124 by last submodule 120 in concatenation 121 (in other words, of the function to be applied first in the composition of functions) in a space (in FIG. 1A: z4) of predetermined probability distribution 111. In this way, the model parameters of first submodule 120 may be learned. Prior to a second training step 125, these model parameters may be fixed, i.e., held constant. Numerical vectors 211 may then continue to propagate in second training step 125 via last submodule 120 into penultimate submodule 122 and may be mapped onto a space (in FIG. 1A: z2) of predetermined probability distribution 111. In this case, the model parameters of the penultimate submodule 122 may be learned, but not however, the last fixed (also: copied) submodule 120. Further training steps, in which in each case the submodule just learned is fixed prior to the next training step, may similarly take place. In FIG. 1A, a third training step 126, for example, is also outlined, via which numerical vectors 211 are able to propagate via fixed submodules 120, 122 into a penultimate submodule 123. The propagation focuses initially on numerical vectors 211 being able to be mapped in the flow direction, model parameters also being capable of being learned in the counter-flow direction (for example, in the case of error backpropagation). In addition, random numbers of the predetermined probability distribution may also propagate in the counter-flow direction using parameterized generic flow-based model 110, see below. The successive learning and freezing of submodules may also be referred to as greedy learning.

Probability distribution 111 predetermined per submodule 120, 122, 123 may be preferably identically selected for all submodules. Alternatively, predetermined probability distributions 111 may also differ from submodule to submodule. It may prove to be advantageous if each predetermined probability distribution 111 may be described and evaluated in closed form. Predetermined probability distributions 111 may preferably be selected per submodule 120 as a normal distribution, i.e. as a Gaussian distribution [symbol] (0,1) with a mean value μ=0 and a variance σ²=1, which may be univariate or multivariate. In FIG. 1A, the progressive learning of the model parameters per submodule may, for example, be directed at variables z0, z2, z4 being situated in each case in a space of a normally distributed random variable. When parameterizable generic flow-based model 110 is successfully trained according to first provided method 200 via numerical vectors 211 of training data set 210, parameterized, i.e., trained, generic flow-based model 110 maps numerical vectors 211 of training data set 210 after each learning step 124, 125, 126 onto random variables of a predetermined probability distribution 111. Thus, the trained generic flow-based model, together with training data set 210, may be viewed as a product of provided first method 200. The generic flow-based model generated in this manner may be used as a machine learning system in the applications described herein.

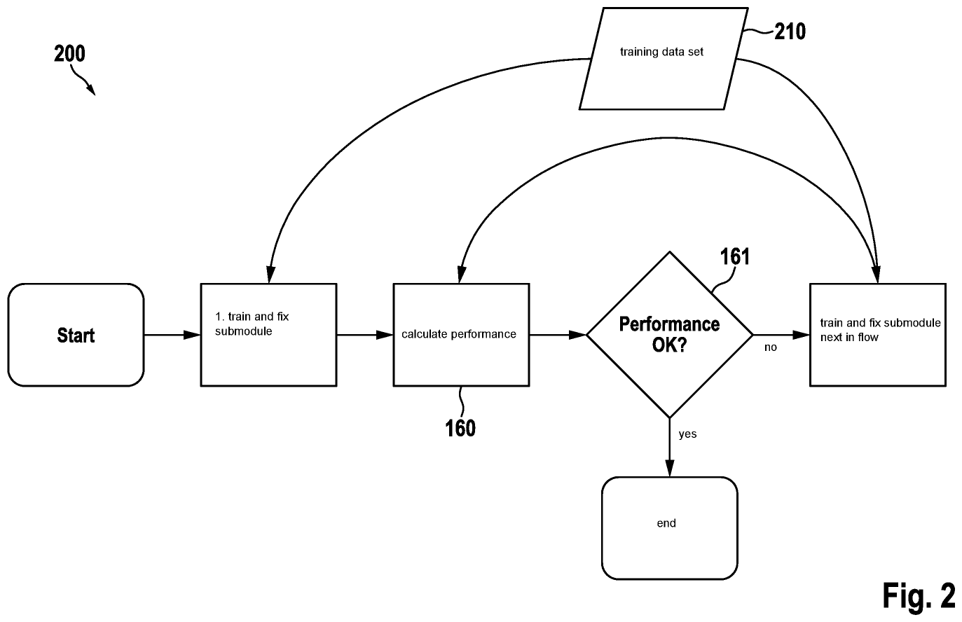

After the learning of every submodule 120, 122, 123, a measure 160 for the performance of the progressive training may be calculated. This may be advantageous insofar as generic flow-based model 110 and its submodules 120, 122, 123 do not have to be completely established prior to the start of the training. Instead, in each case after the learning of every submodule 120, in the flow direction, an extension by further submodules 120 or a reduction by existing submodules 120 may take place for the run time of the training according to a predetermined criterion 161 for the performance of generic flow-based model 110. Predetermined criterion 161 may, for example, include a target value for the performance, in which, after being exceeded or fallen short of, the training is concluded. One possible flowchart for the progressive training is shown in FIG. 2. In addition to the increased flexibility as well as to the increased efficiency resulting for the performance due to the orientation at measure 160, one advantage of the progressive or greedy learning, in particular, in the case of submodule reductions or submodule extensions taking place during the run time, may be seen in a significantly reduced memory requirements. For this reason among others, it is possible to apply the method provided here also in the case of high-dimensional random variables and/or of large volumes of data.

Each submodule 120 may also be or include a concatenation of parameterizable functions, each of which includes a parameterizable so-called transformer 130 as the last chain link, a parameterizable transformer 130 being a parameterizable, invertible mapping, which is differentiable at least once. The concatenation of each submodule 120 may also include multiple transformers 130. In FIG. 1A, for example, each of three submodules 120, 122, 123 includes a concatenation g₅∘g₆, g₃∘g₄ and/or g₁∘g₂ of two parameterizable functions each. Using the concatenation of transformers 130, it is possible to map probability density pₓ(x), represented by numerical vectors 211, x, of training data set 210 and to be determined, in the flow direction onto a base distribution density p_{z}(z), also referred to as probability distribution 111:

$$x = {f}_{L} ∘ … ∘ {f}_{2} ∘ {f}_{1} ( z ) \\ z = {g}_{1} ∘ … ∘ {g}_{L - 1} ∘ {g}_{L} ( x ) \qquad$$

where L is the number of transformers 130 and fₗ=gₗ⁻¹ for l=1, . . . , L. In some examples, base distribution density p_{z}(z) is a normal distribution, the flow-based model then becomes a standardizing flow model. Probability distribution pₓ(x) to be determined may then be calculated from base distribution density p_{z}(z) using z₀=z, z_{L}=x, zₗ=fₗ(zₗ₋₁) and zₗ₋₁=gₗ(zₗ):

$$log {p}_{x} ( x ) = log {p}_{z} ( {g}_{1} ∘ … ∘ {g}_{L - 1} ∘ {g}_{L} ( x ) ) + {\sum }_{l = 1}^{L} log \vert det \frac{\partial {g}_{l} ( {z}_{l} )}{\partial {z}_{l}} \vert \qquad$$

It may prove to be advantageous if a parameterizable transformer 130 is selected in such a way that the determinant

$$det \frac{\partial {g}_{l} ( {z}_{l} )}{\partial {z}_{l}}$$

of the Jacobi matrices is calculable analytically and, in particular, prior to the run time of the training. In this way, it is possible to also process high-dimensional random variables and/or large volumes of data. The formula for log pₓ(x) may be used as a cost function for training machine learning system 100 in the maximization of the maximum-likelihood (for example, maximum likelihood estimation) (for example, via stochastic gradient ascent). If machine learning system 100 is trained, probability density pₓ(x) to be determined may also be referred to as learned probability distribution 213.

At least one submodule 120 of generic flow-based model 110 may include a generic autoregressive flow 140, a generic autoregressive flow 140 including a conditioner parameterizable by model parameters and a transformer 130 parameterizable by model parameters, each conditioner being a function that determines the model parameters of associated transformer 130 and being capable of representing an autoregressive neural network, for example, a convolutional neural network (CNN) or a recurrent neural network (RNN). Each submodule 120 of generic flow-based model 110 may in each case preferably be a generic autoregressive flow or a concatenation of generic autoregressive flows. This may be advantageous insofar as the Jacobi matrices are then triangular matrices, whose determinants may thus be easily calculated in each case by multiplying the diagonal elements.

At least one submodule 120 of generic flow-based model 110 may include a recurrent neural network, optionally, numerical vectors 211 of the at least one training data set 210 propagating via the recurrent neural network into generic flow-based model 110. One advantage may be seen in that in addition to time series 212 of equal length, time series 212 of varying length may then also propagate via the recurrent neural network into generic flow-based model 110. Furthermore, each parameterizable conditioner may include a recurrent neural network.

FIG. 1B schematically shows one specific embodiment of a generic autoregressive flow 140 including a specific transformer 130 f=t,

$${z}_{i} = {t}^{- 1} ( {x}_{i} ; {μ}_{i} ( {x}_{< i} ) , log {σ}_{i} ( {x}_{< i} ) ) = \frac{{x}_{i} - {μ}_{i} ( {x}_{< i} )}{exp log {σ}_{i} ( {x}_{< i} )} \\ {x}_{i} = t ( {z}_{i} ; {μ}_{i} ( {x}_{< i} ) , log {σ}_{i} ( {x}_{< i} ) ) = {μ}_{i} ( {x}_{< i} ) + {z}_{i} exp log {σ}_{i} ( {x}_{< i} ) ,$$

where x_{<i}=(x₁, x₂, . . . , xᵢ₋₁), and a conditioner based on a recurrent neural network,

$${h}_{i - 1} = {f}_{θ} ( {x}_{i - 1} , {h}_{i - 2} )$$

$${μ}_{i} , log {σ}_{i} = {g}_{φ} ( {h}_{i - 1} ) ,$$

where f_{θ} including a parameter set θ and g_{φ} including a parameter set φ represent a recurrent neural network that includes a hidden state hᵢ and g_{φ} may also be parameterized using a fully connected neural network. An autoregressive flow is given, for example, when each conditional probability p(xᵢ|x_{<i}) is Gaussian-distributed, i.e.,

$${x}_{i} ∼ ( {μ}_{i} ( {x}_{< i} ) , {σ}_{i}^{2} ( {x}_{< i} ) )$$

This autoregressive flow may also be understood to be a submodule 120. Such a system may also be referred to as a 1-layer RNNAF, the abbreviation RNNAF standing for an autoregressive flow based on a recurrent neural network.

Starting from numerical vectors 211 x of training data set 210, parameters θ, φ of the recurrent neural network or of the fully connected network may be learned via maximization of the maximum-likelihood. The fully connected neural network in this case may yield the statistics μᵢ, log σᵢ for base distribution p_{z}(z).

Measure 160 for the performance of progressive training 200 may be calculated via a suitable metric. In some examples, the metric may stand for the Kullback-Leibler divergence. For example, the following metric may be calculated:

$$K L ( {q}_{0} ( {z}_{0} ) \vert \vert {p}_{0} ( {z}_{0} ) ) = {{z}_{0} ∼ {q}_{0}}^{E} [ l og \frac{ ( {z}_{0} ; {μ}_{0} , {\sum }_{0} )}{ ( {z}_{0} ; 0 , 1 )} ]$$

where KL(·|·) stands for the Kullback-Leibler divergence. In this case, it may be assumed that a true probability distribution q₀(z₀) of numerical vectors 211 of training data set 210 is a Gaussian distribution z₀˜ [symbol] (μ₀, Σ₀), whose empirical mean value μ₀ and empirical variance Σ₀ may be calculated as follows:

$${μ}_{0} = \frac{1}{N} {\sum }_{i = 1}^{N} {z}_{0}^{( i )}$$

$${\sum }_{0} = \frac{1}{N - 1} {\sum }_{i = 1}^{N} ( {Z}_{0} - {μ}_{0} {1}^{T} ) {( {Z}_{0} - {μ}_{0} {1}^{T} )}^{T}$$

$$where \text{:} {z}_{0}^{( i )} = {g}_{1} ∘ … ∘ {g}_{L - 1} ∘ {g}_{L} ( {x}^{( i )} )$$

$${Z}_{0} = [ {z}_{0}^{( i )} , … , {z}_{0}^{( N )} ]$$

Metric KL(q₀(z₀)∥p₀(z₀)) is all the more smaller the better the flow-based model is trained for the true probability distribution of numerical vectors 211 of training data set 210, in particular, of the at least one time series 212. In contrast to the previously described logarithm of the probability from the cost function for the maximization of the maximum-likelihood, measure 160 for the performance may be viewed as an absolute measure insofar as it estimates the error between true probability distribution q₀(z₀) and the probability distribution of the data according to the model. Such an estimation may be considered to be sufficient insofar as the Kullback-Leibler divergence between the true probability distribution q₀(z₀) and the probability distribution of the data according to the model is unable to be exactly calculated.

Metric KL(q₀(z₀)∥p₀(z₀)) may also be used as an assessment criterion of various standardizing flow models. Thus, it may be shown that a RNNAF is better able to generalize data as compared to a conventional masked autoregressive flow model (MAF) from the related art which, however, is able only to calculate numerical vectors 211, 311 of a fixed dimensionality, in particular, time series 210 of a fixed length.

Alternatively or in addition, the RNNAF described in FIG. 1B may be successively connected multiple times (arbitrarily often) within a submodule. FIG. 1C schematically and by way of example shows such a concatenation of three generic autoregressive flows 140 including in each case, for example, a conditioner based on a recurrent neural network and a transformer 130. Such an autoregressive flow may also be understood to be a submodule 120, where the successive connection of flows may be advantageous in order to learn higher structured probability distributions pₓ(x) (for example, including further moments). From the learned probability distribution, it is also possible to calculate an entropy, which may be advantageous with respect to the compression of information of a time series.

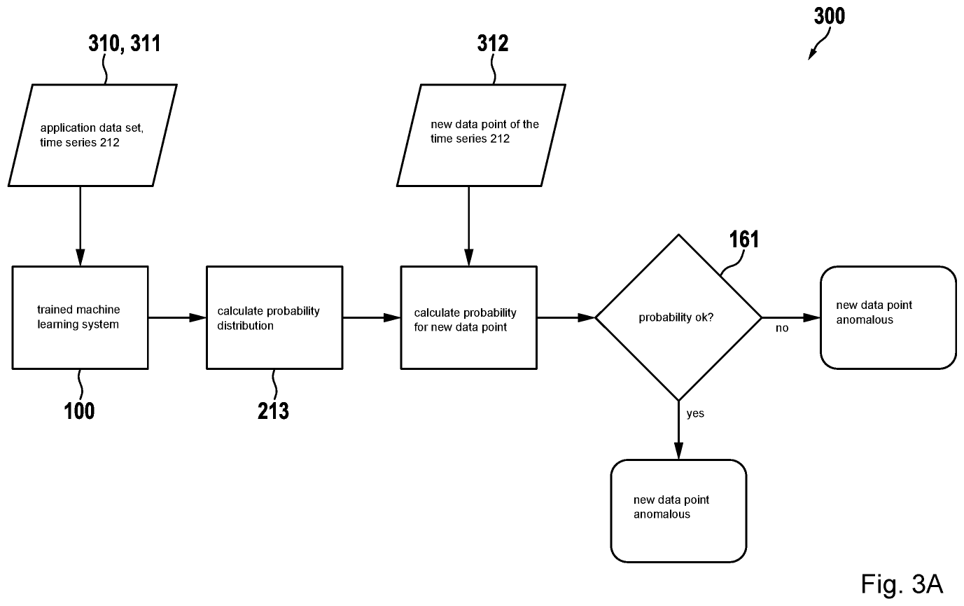

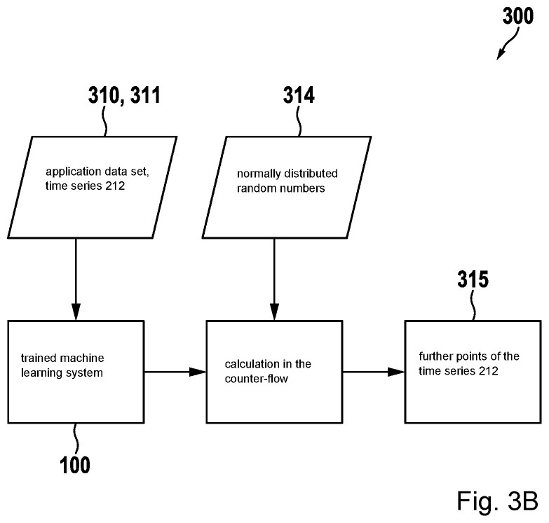

The provided second computer-implemented method 300 is aimed at applying machine learning system 100, machine learning system 100 including at least two submodules 120 and having been configured and trained according to provided first computer-implemented method 200. The method may include the propagation of at least one application data set 310 that includes a number of further numerical vectors 311 in parameterizable generic flow-based model 110. Application data set 310 and training data set 210 may be different or identical. If application data set 310 and training data set 210 differ, machine learning system 100 may (unlike that shown in FIGS. 3A through 3B) be trained via training data set 210 and then applied to application data set 310 using fixed model parameters.

In one example for applying a trained machine learning system, a time series of sensor data 410 and/or of other data of a device may be received. In one further step, a probability for a new data point 312 of time series 212 may be calculated from learned probability distribution 213. For this purpose, new data point 312 in the flow direction, for example, as in FIGS. 1A through 1C, may be mapped into the space of predetermined and known base distribution density p_{z}(z). From the cumulative base distribution density, it is then possible, for example, to calculate the probability as a measure of a compatibility. Since both the training of machine learning system 100 as well as the assessment of a new data point 312 takes place in the flow direction, these processes may be calculated approximately in parallel if training data set 210 and application data set 310 coincide. As shown in one possible flowchart in FIG. 3A, a new data point 312 of a time series 212 may be assessed as an anomaly if its probability violates a further predetermined criterion. Thus, the methods provided here as well as the machine learning system may be designed to recognize anomalies in at least one time series 212, the at least one time series 212 in particular, including sensor data 410. The recognition of an anomaly may in general be used in technical devices or systems for various technical purposes. In one example, the data point recognized as an anomaly may be excluded from a further processing (for example, in order to prevent reactions of a device resulting from artifacts in sensor systems). In one further example, an operating state of a technical device or a state of the surroundings of the technical device may be recognized on the bases of the detected anomaly (for example, a failure of a sensor or a person running onto the road). Alternatively or in addition, a reaction of a technical device may be triggered on the basis of the detected anomaly (for example, an evasive maneuver of an at least semi-autonomous robot or the stopping of a production facility.

More specifically, such an anomaly recognition may be used in different technical contexts. For example, the anomaly recognition may be applied to image data or video data. In the process, a probability density may be learned for a sequence of individual image-based features of at least one series of images or of a video, in particular, of a section of a series of images reduced by object recognition or of at least one video. In new images or videos, new individual image-based features may then be extracted and improbable scenes may be recognized as anomalies. A suitable reaction of a device or of a system may subsequently take place. For example, such an anomaly recognition may be used in monitoring technology or in (medical) imaging processes (for example, in the monitoring of industrial processes or in the findings of image data).

Furthermore, the anomaly recognition may be used during at least semi-autonomous driving (or in other at least semi-autonomous transportation means or robots). For this purpose, features (for example, information, in particular, safety-relevant information, about the surroundings and/or about further road users) may be extracted for a sequence of sensor data 410 or of other data (for example, video, LIDAR, ultrasonic sensors or thermal sensors, communication with other vehicles or devices or a combination of two or more of these data sources) of a vehicle (or in other at least semi-autonomous robots), in particular of an at least semi-autonomous vehicle 400. Such features may include, for example, 3D world coordinates and/or coordinates relative to the vehicle, to objects of the surroundings or to road users. A probability density may be learned for these features. The trained model may then be used in a vehicle 400 (or in other at least semi-autonomous robots). If new sensor data are recorded, features may be extracted and analyzed. In this way, unforeseen operating situations, for example, (driving situations, for example) may be recognized as anomalies and countermeasures (for example, deceleration, lane changing or emergency brake application) may be initiated.

In other examples, features (for example, eye movement or heart rate) that contain information about the state of an operator of a device or of a system (for example, a machine), in particular, of a vehicle, may be extracted for a sequence of sensor data 410 or of other data (for example, video, steering signal, gas pedal signal/acceleration, braking signal, communication with a smartwatch of the driver). A model trained for such features may then process new measuring signals and recognize anomalies therein. Thus, an operator of a device or of a system (for example, of a machine), in particular, a driver of a vehicle, may then be monitored with respect to his/her operating fitness.

In yet other examples, features that contain information about the dynamics of a device or of a system (for example, of a machine) may be extracted for a sequence of sensor data 410 (for example, of an electronic control unit or derived variables). Using anomaly recognition, the device or the system (for example, the machine), in particular, an engine, may then be monitored with respect to functional fitness.

In further examples, an anomaly monitoring may be used for a sequence of sensor data 410 for analyzing and responding in an Internet of Things (for example, smart home or smart manufacturing) for networking physical and virtual objects. A trained model may then monitor and analyze sensor signals (for example, temperature or oxygen quantity) or features extracted therefrom for new data, for example, in an industrial plant. In the case of abnormalities, measures (for example, a production stop, an increase in the fresh air supply or an emergency stop) may then be prompted.

In further examples, a probability density may be learned for a sequence of utilized capacity data in nodes of a network, in particular, of a computer network, of a telecommunications network or of a wireless network (for example, a 5G wireless network). For new data, the trained model may then assess and/or recognize anomalous behavior, in particular, a network attack.

In the case of a network attack, a node may then be switched off, for example.

In provided second method 300, new data points 315, for example, may be further generated for continuing a time series 212, in particular, of sensor data 410, new data points 315 resulting from data points 314 of predetermined probability distribution 111, in particular, from normally distributed data points 314, in the counter-flow direction. For this purpose, (pseudo) random numbers may be generated according to predetermined base distribution density p_{z}(z), which are then mapped in the counter-flow direction, for example, as in FIGS. 1A through 1C into the space of time series 212. Such an approach is shown in FIG. 3B. New data points 315 may be used for controlling a device or a technical system. Alternatively or in addition, a state of a device or of a technical system may be determined on the basis of the new data points. The device or the technical system in this case may be virtual (i.e., with the aid of the methods of the present description, may be used for simulating the behavior of the device or of a technical system).

Such a continuation of at least one time series 212 may also be used in different technical contexts.

In examples, features in a vehicle 400 (for example, electric vehicle or hybrid vehicle), which may provide information about an operating state of the vehicle (for example, the traction battery and, in particular, about its state of health) may be extracted for a sequence of driving data 410 (for example, speed, height, battery data). Via a model trained for such features, numerous instances of operating states (for example, battery sizes and, in particular, states of health) may then be simulated through continuation. Using, for example, a suitable statistical evaluation (for example, mean value formation) and/or taking a known future into consideration (for example, target data from the navigation device), a suitable operating strategy of the vehicle (for example, a vehicle strategy and/or hybrid strategy, in particular, a battery saving mode) may then be selected.

In other examples, with respect to the formation of a digital twin, a prototype of a device to be newly developed (for example, a performance tool, an application for the private household, a new machine) may be measured via internal and/or external sensors (for example, video, LIDAR) for a particular type of use. Features may then be extracted from these measurements. A model trained for such features may then generate new instances of features. These may then be analyzed with regard to possible abnormalities (for example, excessive power requirement, premature failure, overheating). In the case of such abnormalities, the device may, for example, be switched off or transferred into a safe mode. For example, a model may be trained for a sequence of sensor data 410 of one part of a digital twin in order to simulate data of another part of the digital twin.

In further examples, time series for the resource assignment in a network, in particular, in a computer network, in a telecommunications network (for example, a 5G network) and/or in a wireless network, may be continued in a simulative manner. For this purpose, the utilized capacity (or further parameters such as, for example, temperature or time of day) may be detected in various nodes of the network and features extracted therefrom. A model trained for such features may then be applied to new data. By generating new data points, the utilized capacity in the network may then be simulated. Network resources may be assigned based on the simulated utilized capacity. Additional resources may be assigned if the simulated utilized capacity in a certain node of the network exceeds a certain threshold value. The prediction of the utilized capacity may also be used for the routing algorithms and/or for an overload control. For example, the resources in a wireless network such as bandwidth or transmission power are limited at each access point and are therefore assigned only on-demand. The resource manager is able to assign, for example, transmission time ranges, frequency, power and transmission format to an access point as a function, for example, of the user application type (for example, an Internet of Things user or a mobile phone user), of the required service quality (for example, data transfer rate, reliability, time delay), of the communication channel condition (for example, signal to interference or noise ratio). The better the prediction of the load algorithm is, the more timely and reliably the assignment of resources is able to take place. Bandwidth may be reserved if, for example, delays due to critical traffic are predicted. A reliable prediction of the utilized capacity is critical, in particular, in increasingly more complex and dynamic networks such as, for example, 5G, in which the number of users and the required quality of service continually increases.

In addition to the parameterizable generic flow-based model 110 in the provided first and second method, which includes a concatenation 121 of at least two parameterizable submodules 120, 121, a parameterizable generic flow-based model 110 that includes only one submodule 120, which includes a concatenation of autoregressive flows, in particular, a multi-layer RNNAF as in FIG. 1C may also be trained by maximizing the maximum-likelihood for a submodule 120 (i.e., “end-to-end”) and may be applied as in the provided second method.

The provided computer-implemented methods and systems may also be adapted to multivariate time series data.

The present description also relates to computer programs, which are configured to carry out all steps of the methods of the present description. In addition, the present description relates to machine-readable memory media (for example, optical memory media or read-only memories, for example, FLASH memory), on which computer programs are stored, which are configured to carry out all steps of the methods of the present description.

1-16. (canceled)

17. A computer-implemented method for training a machine learning system, comprising:
providing at least one training data set that includes a number of numerical vectors; and
propagating the numerical vectors of the at least one training data set through a parameterizable generic flow-based model, the parameterizable generic flow-based model including a concatenation of at least two parameterizable submodules, each of the submodules being a parameterizable function; and
learning model parameters of the parameterizable generic flow-based model;
wherein parameterizations of each of the parameterizable submodules are learned successively in a flow direction of the parameterizable generic flow-based model and are fixed before parameterizations of the parameterizable submodule next in the flow direction are learned, and the learning being directed at output data of each of the submodules being distributed according to a predetermined probability distribution.

18. The computer-implemented method for training a machine learning system as recited in claim 17, wherein at least one of the submodules of the generic flow-based model includes a generic autoregressive flow.

19. The computer-implemented method for training a machine learning system as recited in claim 18, wherein each generic autoregressive flow includes a conditioner parameterizable by model parameters and an associated transformer parameterizable by model parameters, each conditioner being a function that determines the model parameters of the associated transformer and is an autoregressive neural network.

20. The computer-implemented method for training a machine learning system as recited in claim 18, wherein at least one of the submodules of the generic flow-based model includes a recurrent neural network.

21. The computer-implemented method for training a machine learning system as recited in claim 20, wherein the numerical vectors of the at least one training data set propagate via the recurrent neural network into the generic flow-based model.

22. The computer-implemented method for training a machine learning system as recited in claim 21, wherein time series of differing length propagate via the recurrent neural network into the generic flow-based model.

23. The computer-implemented method for training a machine learning system as recited in claim 17, wherein a measure for performance is calculated after the learning of each respective submodule of the submodules, the performance being determined via a Kullback-Leibler divergence between the predetermined probability distribution and a distribution of the output data of the respective submodule and, after the learning of each of the submodules according to a predetermined criterion for the performance, the generic flow-based model is extended by further submodules or is reduced by existing submodules.

24. The computer-implemented method for training a machine learning system as recited in claim 17, wherein each of the submodules is a concatenation of parameterizable functions, each of which includes a parameterizable transformer as a final chain link of the concatenation, the parameterizable transformer being a parameterizable invertible mapping.

25. The computer-implemented method for training a machine learning system as recited in claim 17, wherein the predetermined probability distributions are each a normal distribution.

26. A computer-implemented method for applying a trained machine learning system, the method comprising:
applying the trained machine learning system, the trained machine learning system being trained by:
providing at least one training data set that includes a number of numerical vectors, and
propagating the numerical vectors of the at least one training data set through a parameterizable generic flow-based model, the parameterizable generic flow-based model including a concatenation of at least two parameterizable submodules, each of the submodules being a parameterizable function, and
learning model parameters of the parameterizable generic flow-based model,
wherein parameterizations of each of the parameterizable submodules are learned successively in a flow direction of the parameterizable generic flow-based model and are fixed before parameterizations of the parameterizable submodule next in the flow direction are learned, and the learning being directed at output data of each of the submodules being distributed according to a predetermined probability distribution.

27. The computer-implemented method for applying a trained machine learning system as recited in claim 26, further comprising:
receiving a time series of sensor data of a device; and
calculating a probability for a new data point of the time series from the learned probability distribution; and
assessing the data point of the time series as an anomaly when the probability for the data point violates a further predetermined criterion.

28. The computer-implemented method for applying a trained machine learning system as recited in claim 27, wherein the time series includes:
a sequence of image data or audio data; or
a sequence of data for monitoring an operator of a device or of a system; or
a sequence of data for monitoring or controlling a device or a system; or
a sequence of data for monitoring or controlling an at least semi-autonomous robot.

29. The computer-implemented method for applying a trained machine learning system as recited in claim 26, further comprising:
generating new data points for continuing a time series of sensor data resulting from normally distributed data points in a counter-flow direction of the parameterizable generic flow-based model; and
(i) controlling a device or a system based on the new data points, or (ii) determining a state of a device or of a system based on the new data points.

30. The computer-implemented method for applying a trained machine learning system as recited in claim 29, wherein the at least one time series for continuation includes:
a sequence of data of an at least semi-autonomous vehicle to select a vehicle strategy; or
a sequence of sensor data of one part of a digital twin to simulate data of another part of the digital twin; or
a sequence of utilized capacity data in nodes of a network for simulating and analyzing utilized capacity, in order to assign network resources based on the simulated utilized capacity, the network being a computer network or a telecommunications network or a wireless network.

31. A computer-implemented system for training a machine learning system, the computer-implemented system configured to:
provide at least one training data set that includes a number of numerical vectors; and
propagate the numerical vectors of the at least one training data set through a parameterizable generic flow-based model, the parameterizable generic flow-based model including a concatenation of at least two parameterizable submodules, each of the submodules being a parameterizable function; and
learn model parameters of the parameterizable generic flow-based model;
wherein parameterizations of each of the parameterizable submodules are learned successively in a flow direction of the parameterizable generic flow-based model and are fixed before parameterizations of the parameterizable submodule next in the flow direction are learned, and the learning being directed at output data of each of the submodules being distributed according to a predetermined probability distribution.

32. A non-transitory machine-readable memory medium on which is stored a computer program for training a machine learning system, the computer program, when executed by a computer, causing the computer to perform the following steps:
providing at least one training data set that includes a number of numerical vectors; and
propagating the numerical vectors of the at least one training data set through a parameterizable generic flow-based model, the parameterizable generic flow-based model including a concatenation of at least two parameterizable submodules, each of the submodules being a parameterizable function; and
learning model parameters of the parameterizable generic flow-based model;
wherein parameterizations of each of the parameterizable submodules are learned successively in a flow direction of the parameterizable generic flow-based model and are fixed before parameterizations of the parameterizable submodule next in the flow direction are learned, and the learning being directed at output data of each of the submodules being distributed according to a predetermined probability distribution.
